(19) United States
(12) Patent Application Publication
(10) Pub. No.: US 2015/0282047 A1
(43) Pub. Date: Oct. 1, 2015

(54) NETWORK RESOURCE USAGE

(71) Applicants: Samuli TURTINEN, Ii (FI); Sami-Jukka HAKOLA, Kempele (FI); Timo KOSKELA, Oulu (FI); Jari ISOKANGAS, Tampere (FI); RENESAS MOBILE CORPORATION, Chiyoda-ku, Tokyo (JP)

(72) Inventors: Samuli Turtinen, Ii (FI); Sami-Jukka Hakola, Kempele (FI); Timo Koskela, Oulu (FI); Jari Isokangas, Tampere (FI)

(21) Appl. No.: 14/432,093

(22) PCT Filed: Sep. 26, 2013
(86) PCT No.: PCT/IB2013/058898

§ 371 Date: Mar. 27, 2015

(30) Foreign Application Priority Data
Sep. 27, 2012 (GB) 1217315.9

(51) Int. Cl. H04W 48/02; H04W 76/02

(52) U.S. Cl. CPC H04W 48/02; H04W 76/027; H04W 88/06

(57) ABSTRACT

In a multi-RAT user equipment autonomous denials are used to stop LTE transmission to free frames or subframes for the transmission of e.g Bluetooth or WLAN signals. The use of the autonomous denials is limited per defined time period. The start of this time window may not be synchronised between UE and eNB. To avoid any synchronisation problems, a system frame number associated with the network entity is used as the basis for generating an indicator for the start of the time period. The indicator is then transmitted to the user equipment, which is adapted to respond to receipt of the indicator by configuring the user equipment to perform no more than a predetermined number of autonomous denials during the time period. The number of unsuccessful transmissions during the time period is then monitored by the network entity, and resource usage within the wireless communications network is selectively adapted on the basis of the monitoring.

### TECHNICAL FIELD

Embodiments of the present invention relate to controlling resource usage in a wireless communications network, and in particular to controlling autonomous denials between a user equipment and a network entity.

### BACKGROUND

User equipment (UE) is a general term used to describe a communication device capable of connecting wirelessly to a network, and in particular mobile communication devices. Modern UEs are routinely capable of connecting to various types of wireless communications networks, often simultaneously. A given UE may for example include one or more cellular radio modules for connecting to a cellular wireless network, and one or more non-cellular radio modules for connecting to non-cellular wireless networks (such as Wi-Fi, Bluetooth etc.). As a result of communicating simultaneously via two radio modules, a user equipment may be subject to in-device interference. In-device interference describes the interference generated at one radio module on a given UE that results from a transmission made via another radio module on the same UE. In some circumstances, this interference occurs at a frequency which causes degradation to signals being received at the respective radio module and can prevent effective reception of those signals.

FIG. 1 illustrates the effects of in-device interference on time-magnitude graphs 100a and 100b. Graph 100a illustrates a series of uplink transmissions 102 made by a given UE via a first radio module at times tₐ, t_{b}, t_{c}, t_{d}, tₑ, t_{f}, t_{g} and tₕ. Graph 100b illustrates a series of downlink transmissions 104 received at the given UE via a second radio module at times tₐ, t_{c}, tₑ and t_{g}. The term uplink is used to describe those transmissions which are transmitted from the given UE to a remote entity, while the term downlink is used to describe those transmissions which are received at the given UE from a remote entity. Graph 100b also shows the in-device interference 106 caused at the second radio module at times tₐ, t_{b}, t_{c}, t_{d}, tₑ, t_{f}, t_{g} and tₕ as a result of the uplink transmissions 102 made via the first radio module. If the in-device interference 106 occurs at a frequency which causes degradation to the quality of the received downlink transmissions 104, the UE may be prevented from receiving those transmissions effectively.

In order to mitigate the effects in-device interference, it has recently been proposed in relation to LTE (Long Term Evolution) to include mechanisms that provide for a system of autonomous denials. Under such systems, if the UE detects or suspects that it is suffering from in-device interference the UE is able to elect to forego an uplink transmission so as to enable the effective receipt of a downlink transmission via another radio module.

FIG. 2 illustrates the effects of autonomous denials for mitigating in-interference on time-magnitude graphs 200a and 200b. Graph 200a illustrates the series of uplink transmissions 202 scheduled to be made by the given UE via the first radio module at times tₐ, t_{b}, t_{c}, t_{d}, tₑ, t_{f}, t_{g} and tₕ. However, in order to enable effective reception of downlink transmissions 204, a number of autonomous denials have been made by the UE in relation to the uplink transmissions scheduled to be made at times tₐ, t_{c}, tₑ and t_{g}; these transmissions are indicated by the broken lines on graph 200a. Hence, those scheduled transmissions do not take place.

Graph 200b illustrates the series of downlink transmissions 204 received at the given UE via the second radio module at times tₐ, t_{c}, tₑ and t_{g}. Graph 200b also shows the in-device interference 206 caused at the second radio module at times t_{b}, t_{d}, t_{f} and tₕ as a result of the uplink transmissions 202 made via the first radio module. Because of the autonomous denials performed by the UE, the in-device interference 206 does not occur at the second radio module at the same time as the receipt of downlink transmissions 204. Hence, effective receipt of transmissions 204 is enabled.

Despite helping to mitigate the effects of in-device interference, the use of autonomous denials by a UE raises further problems. Firstly, autonomous denials represent wasted bandwidth because the portion of the frequency spectrum allocated for the denied transmission is typically unused during the relevant period. Secondly, it is not apparent to the network entity with which the UE is communicating whether the reason that a given transmission is unsuccessful is due to an autonomous denial performed by the UE, or because of a problem with the communication link quality between the UE and the network entity. If it is the latter, then action should be taken to improve the communication link quality. However, if it is the former, then any action taken to improve the communication link quality would likely be unnecessary and therefore wasted.

To overcome these problems with autonomous denials, it has been proposed to limit the number of autonomous denials that the UE is allowed to perform. Firstly this reduces the bandwidth can be wasted through the use of autonomous denials. Secondly, if the number of unsuccessful transmissions exceeds the autonomous denial limit, then the network entity conducting communications with the UE can determine that at least some of the transmissions have been missed due to link quality. A desirable method for limiting the number of autonomous denials is to set a maximum number of autonomous denials that may be performed in a specific time period.

FIG. 3 illustrates the effects of limiting the number of autonomous denials that can be performed in a fixed time period on time-magnitude graphs 300a and 300b. In this scenario, the UE is permitted to perform no more than two autonomous denials in the time period T between time t₁ and t₂. Graph 300a illustrates the series of uplink transmissions 302 scheduled to be made by the given UE via the first radio module at times tₐ, t_{b}, t_{c}, t_{d}, tₑ, t_{f}, t_{g} and tₕ. However, in order to enable effective reception of downlink transmissions 304 by the second radio module, a number of autonomous denials are desired to be made by the UE in relation to the uplink transmissions scheduled at times tₐ, t_{c}, tₑ and t_{g}. The transmissions scheduled to be made at times tₐ and t_{c} do not take place due to successful autonomous denials performed by the UE, as shown by the broken lines on graph 300a. However, at time tₑ, the UE has already performed the maximum number of autonomous denials during the time period T and hence the uplink transmission scheduled at time tₑ does take place. At time T2, a new time period begins and the number of allowed autonomous denials is reset. The UE is then able to make a successful autonomous denial at time t_{g}. Hence, the transmission scheduled to be made at time t_{g} does not take place, as shown by the broken line on graph 300a.

Graph 300b illustrates the series of downlink transmissions 304 received at the in-device interference 306 caused at the second radio module at times t_{b}, t_{d}, tₑ, t_{f} and tₕ as a result of the uplink transmissions 302 made via the first radio module. As a result of the autonomous denials performed by the UE, the in-device interference 306 does not occur at the second radio module at the same time as the receipt of the downlink transmissions at times tₐ, t_{c} and t_{g}. However, the downlink transmission received at time tₑ is subjected to in-device interference.

If all of the uplink transmissions that are transmitted by the UE are all received by the network entity, then the number of unsuccessful transmissions detected by the network entity (i.e. those that were subject to autonomous denials by the UE) during the time period T will not exceed the maximum number of autonomous transmissions allowed. However, if a sufficient number of the uplink transmissions that are transmitted by the UE do not reach the network entity (in this case, one), then the number of unsuccessful transmissions detected by the network entity during the time period T will exceed the maximum number of autonomous transmissions allowed. In that case, the network entity can determine that at least one of the scheduled transmissions was not received due to a problem with the wireless communications link quality.

However, problems may arise if the time period T is not accurately synchronised between the UE and the network entity. Such synchronisation is hard to achieve in practice as it is difficult for the network entity to determine exactly when the UE considers the time period to start. For example, if the UE is configured to consider the start of the time period as the time at which a first autonomous denial is performed, the network entity would have to consider the start of the time period as the time at which a first unsuccessful transmission is detected. However, the network entity has no way of determining the cause of the unsuccessful transmission and therefore may erroneously start the time period after detecting an transmission lost due to poor link quality, which would result in time periods that are unsynchronised between the network entity and the UE. Alternatively, if absolute times are used to define the start and end of the time period, then propagation times of the uplink and/or downlink transmissions may need to be considered. For example, a transmission made by the UE at the end one time period may arrive at the network entity after the start of the next time period etc.

FIG. 4 illustrates the effects of a time period that is not synchronised sufficiently accurately between the UE and the network entity on time-magnitude graphs 400a and 400b. In this scenario, the UE is again permitted to perform no more than two autonomous denials during the time period T. However due to the lack of accurate synchronisation between the UE and the network entity, the specific start and end of the time period T as recorded by the UE and the network entity are not aligned. The UE considers the time period T to be the time starting at t₁ (i.e. prior to the transmission made at time tₐ) and ending at t₂ (i.e. between the transmissions made at times t_{f} and t_{g}), as shown by T_{UE} in FIG. 4. The network entity understands the time period T to be the time starting at t₃ (i.e. between the transmissions made at times tₐ and t_{b}) and ending at t₄ (i.e. between the transmissions made at times t_{g} and tₕ) as shown by T_{NE} in FIG. 4.

Graph 400a illustrates the series of uplink transmissions 402 scheduled to be made by the given UE via the first radio module at times tₐ, t_{b}, t_{c}, t_{d}, tₑ, t_{f}, t_{g} and tₕ. However, in order to enable effective reception of downlink transmissions 304, a number of autonomous denials are desired to be made by the UE in relation to the uplink transmissions scheduled at times t_{c}, tₑ and t_{g}. The transmissions scheduled to be made at times t_{c} and tₑ do not take place due to successful autonomous denials performed by the UE, as shown by the broken lines on graph 400a. At time t_{g}, the UE understands that a new time period has begun and the number of allowed autonomous denials has been reset. The UE is then determines that it is able to make another successful autonomous denial at time t_{g}. Hence, the transmission scheduled to be made at time t_{g} does not take place, as shown by the broken line on graph 400a.

Graph 400b illustrates the series of downlink transmissions 404 received at the UE via the second radio module at times t_{c}, tₑ and t_{g}. Graph 400b also shows the in-device interference 406 caused at the second radio module at times tₐ, t_{b}, t_{d}, t_{f} and tₕ as a result of the uplink transmissions 402 made via the first radio module. As a result of the autonomous denials performed by the UE, the in-device interference 306 does not occur at the second radio module at the same time as the receipt of the downlink transmissions at times t_{c}, tₑ and t_{g}.

Due to the lack of accurate synchronisation between the UE and the network entity, the network entity assesses the number of successful transmissions that have been made during time period T_{NE}. In this scenario, even if all of the uplink transmissions that are transmitted by the UE are received by the network entity, the number of unsuccessful transmissions detected by the network entity during its understanding of the time period T will exceed the maximum number of autonomous transmissions allowed. This is because, according to the network entity, the uplink transmission made at time t_{g} falls within the time period T. Hence, despite no unsuccessful transmissions being the result of a poor quality wireless communications link, the network entity will erroneously assume that this is the case.

Hence, it would be desirable to provide improved measures for synchronisation of a time period between a user equipment and a network entity, particularly for limiting the number autonomous denials of scheduled transmissions.

### SUMMARY

In accordance with a first exemplary embodiment, there is provided a method of controlling autonomous denials in relation to transmissions between a user equipment and a network entity in a wireless communications network, wherein the network entity has a system frame number associated therewith, the method comprising:

receiving, at the user equipment, a configuration message, the configuration message comprising an indicator for a start time of a time period, wherein the indicator is derived from the system frame number; and

configuring the user equipment on the basis of the indicator to perform no more than a predetermined number of autonomous denials during said time period.

In accordance with a second exemplary embodiment, there is provided an apparatus for controlling autonomous denials in relation to transmissions between a user equipment and a network entity in a wireless communications network. The apparatus comprises a processing system, which may be embodied by processing circuitry or a memory and at least one computer program, and is arranged, responsive to receipt of a configuration message comprising an indicator for a start time of a time period, to configure the user equipment on the basis of the indicator to perform no more than a predetermined number of autonomous denials during said time period, wherein the indicator is derived from a system frame number associated with the network entity.

In accordance with a third exemplary embodiment, there is provided a computer program comprising a set of instructions, which, when executed by a computing device, causes the computing device to carry out a method of controlling autonomous denials in relation to transmissions between a user equipment and a network entity in a wireless communications network, wherein the network entity has a system frame number associated therewith, the method comprising:

receiving, at the user equipment, a configuration message, the configuration message comprising an indicator for a start time of a time period, wherein the indicator is derived from the system frame number; and

configuring the user equipment on the basis of the indicator to perform no more than a predetermined number of autonomous denials during said time period.

The first, second and third exemplary embodiments may be practised by and configured within a user equipment.

By using the system frame number as the basis for synchronisation of a time period between the user equipment and the network entity, the first, second and third exemplary embodiments enable the user equipment to ensure that it has the same understanding as the network entity regarding the point in the sequence of transmissions at which the time period starts. Hence, the user equipment is effectively enabled to determine the number of autonomous denials that it may perform during the time period will not, in isolation, cause the network entity to perceive that the predetermined number has been exceeded.

In accordance with a fourth exemplary embodiment, there is provided a method of controlling resource usage within a wireless communications network, the wireless network comprising a user equipment and a network entity, wherein the network entity has a system frame number associated therewith, the method comprising:

using the system frame number to generate an indicator for a start time of a time period;

transmitting a configuration message to the user equipment, the configuration message comprising the indicator;

monitoring the number of unsuccessful transmissions between the user equipment and the network entity during said time period; and

selectively adapting resource usage within the wireless communications network on the basis of the monitoring.

In accordance with a fifth exemplary embodiment, there is provided an apparatus for controlling resource usage within a wireless communications network, the wireless network comprising a user equipment and a network entity. The apparatus comprises a processing system, which may be embodied by processing circuitry or a memory and at least one computer program, and is arranged to: generate an indicator for a start time of a time period using a system frame number associated with the network entity; transmit a configuration message to the user equipment, the configuration message comprising the indicator; monitor the number of unsuccessful transmissions between the user equipment and the network entity during said time period; and selectively adapt resource usage within the wireless communications network on the basis of the monitoring.

In accordance with a sixth exemplary embodiment there is provided a computer program comprising a set of instructions, which, when executed by a computing device, causes the computing device to carry out a method of controlling resource usage within a wireless communications network, the wireless network comprising a user equipment and a network entity, wherein the network entity has a system frame number associated therewith, the method comprising:

using the system frame number to generate an indicator for a start time of a time period;

transmitting a configuration message to the user equipment, the configuration message comprising the indicator;

monitoring the number of unsuccessful transmissions between the user equipment and the network entity during said time period; and

selectively adapting resource usage within the wireless communications network on the basis of the monitoring.

The fourth, fifth and sixth exemplary embodiments may be practised by and configured within a network entity.

By using the system frame number as the basis for synchronisation of a time period between the user equipment and the network entity, the fourth, fifth and sixth exemplary embodiments enable the network entity to ensure that it has the same understanding as the user equipment regarding the point in the sequence of transmissions at which the time period starts. Hence, the network entity is enabled to more precisely pinpoint the cause of unsuccessful transmissions, and therefore more effectively adapt resource usage within the wireless communications network.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates the effects of in-device interference in the time domain.

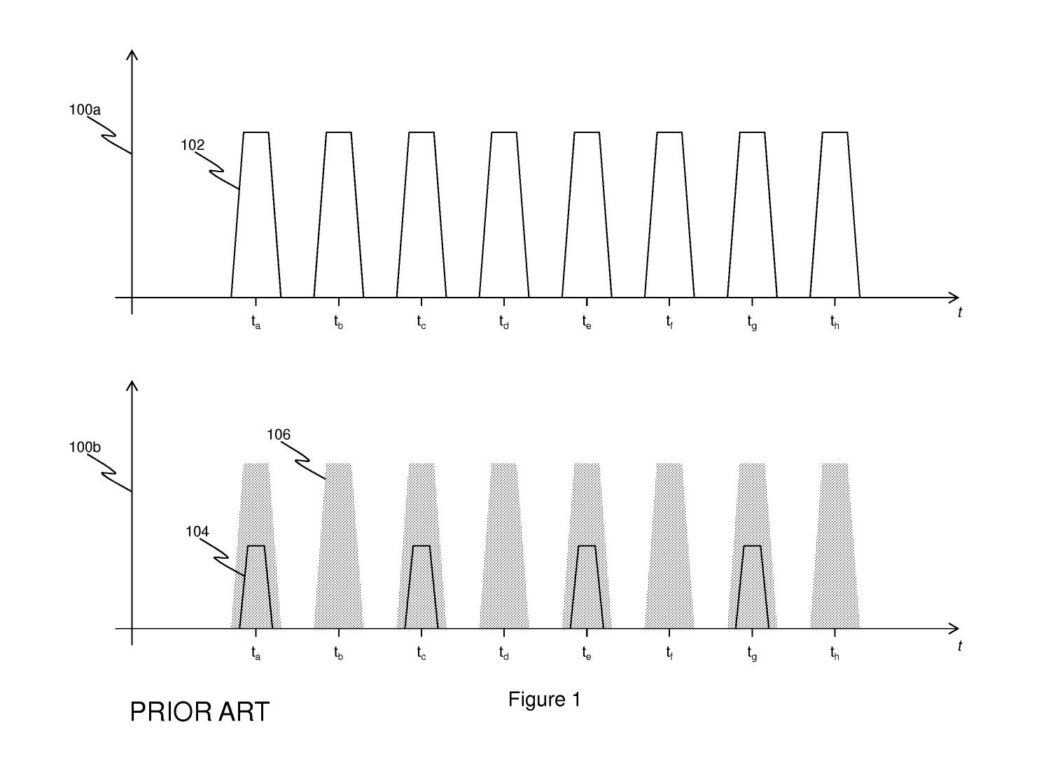

FIG. 2 illustrates the effects of autonomous denials for mitigating in-interference in the time domain.

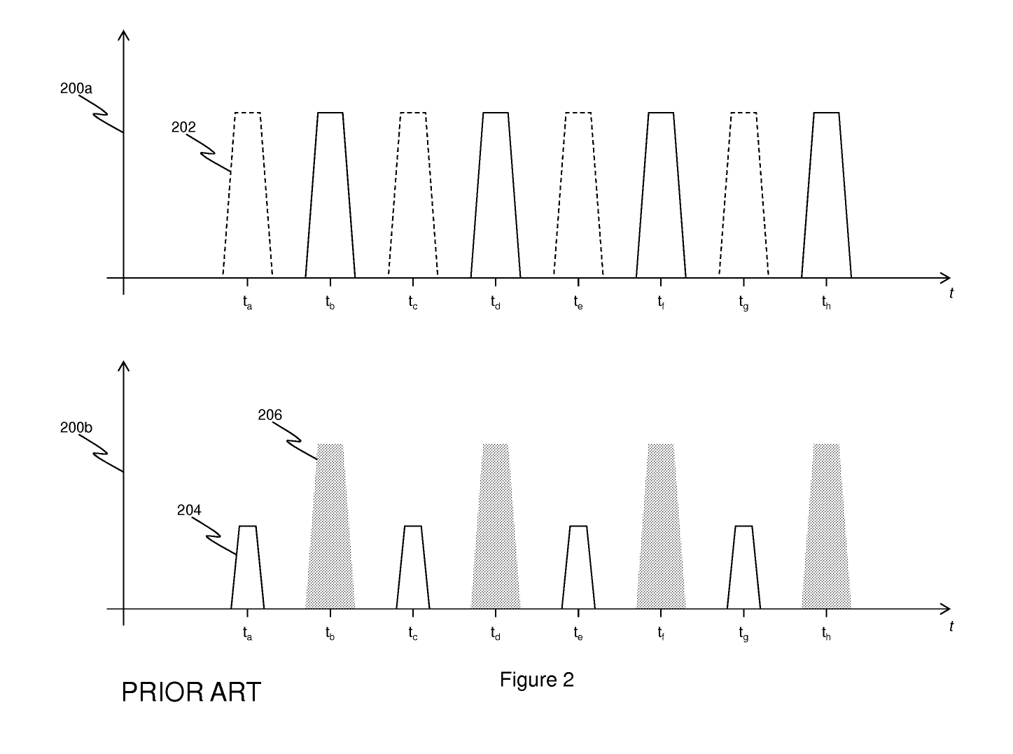

FIG. 3 illustrates the effects of limiting the number of autonomous denials in the time domain.

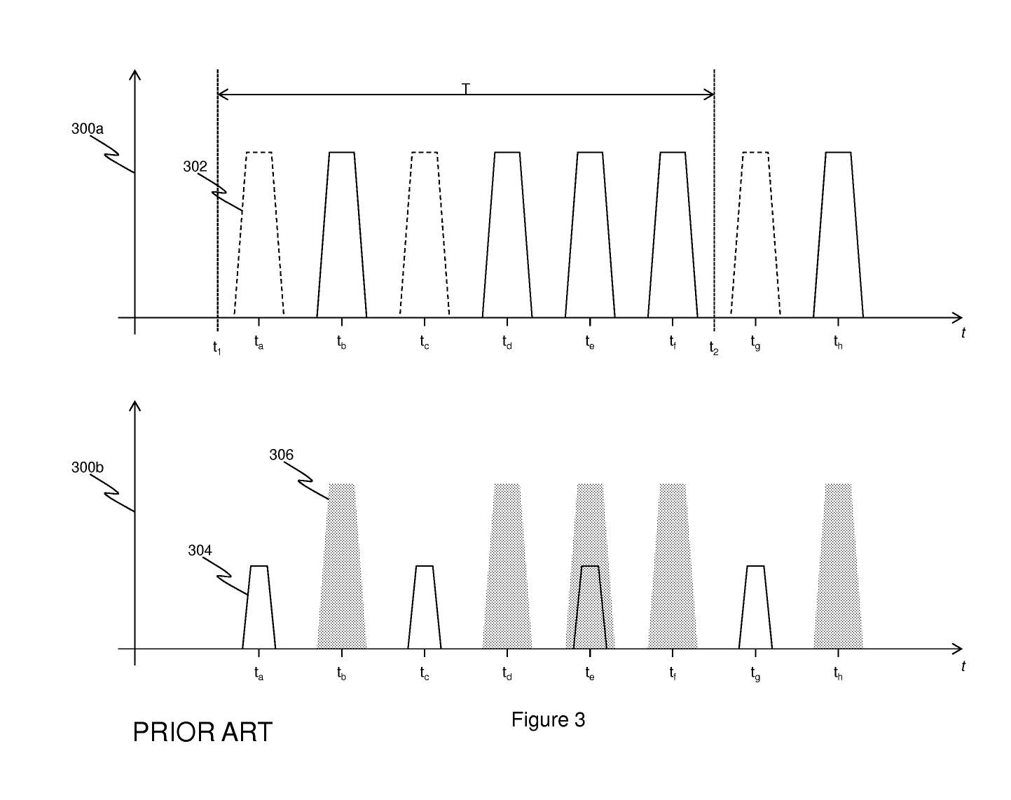

FIG. 4 illustrates the effects of inaccurate time period synchronisation in the time domain.

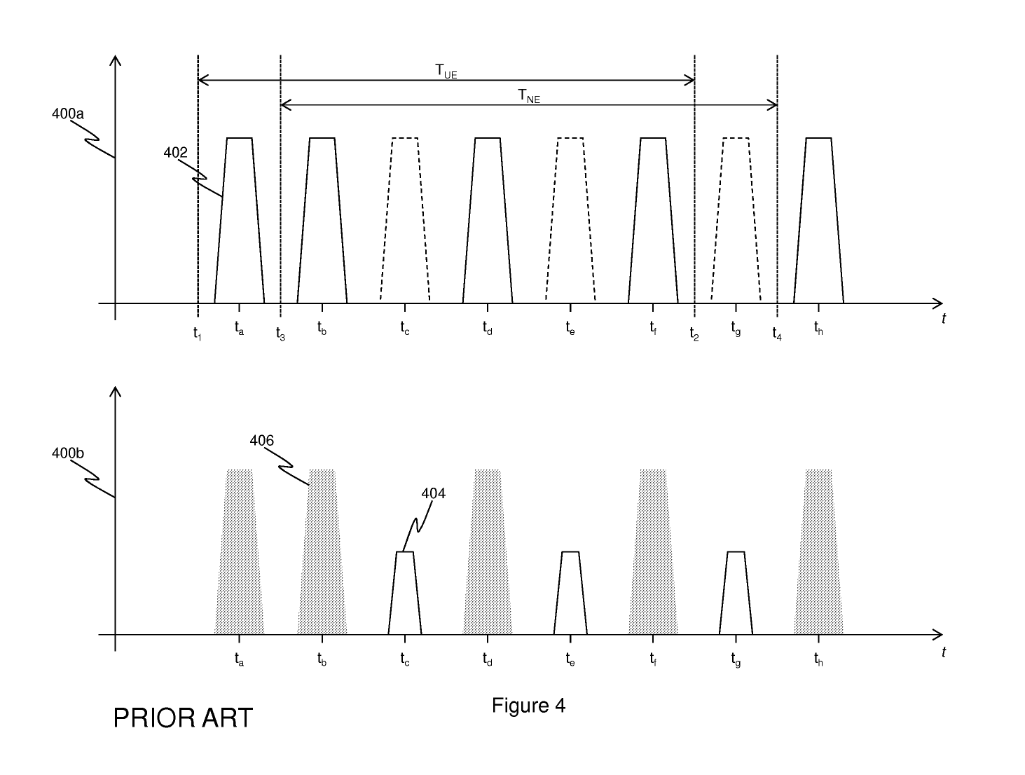

FIG. 5 shows a schematic diagram of a wireless communications network according to embodiments.

FIG. 6 shows a flow diagram describing embodiments from the perspective of the user equipment.

FIG. 7 shows a flow diagram describing embodiments from the perspective of the network entity.

### DETAILED DESCRIPTION

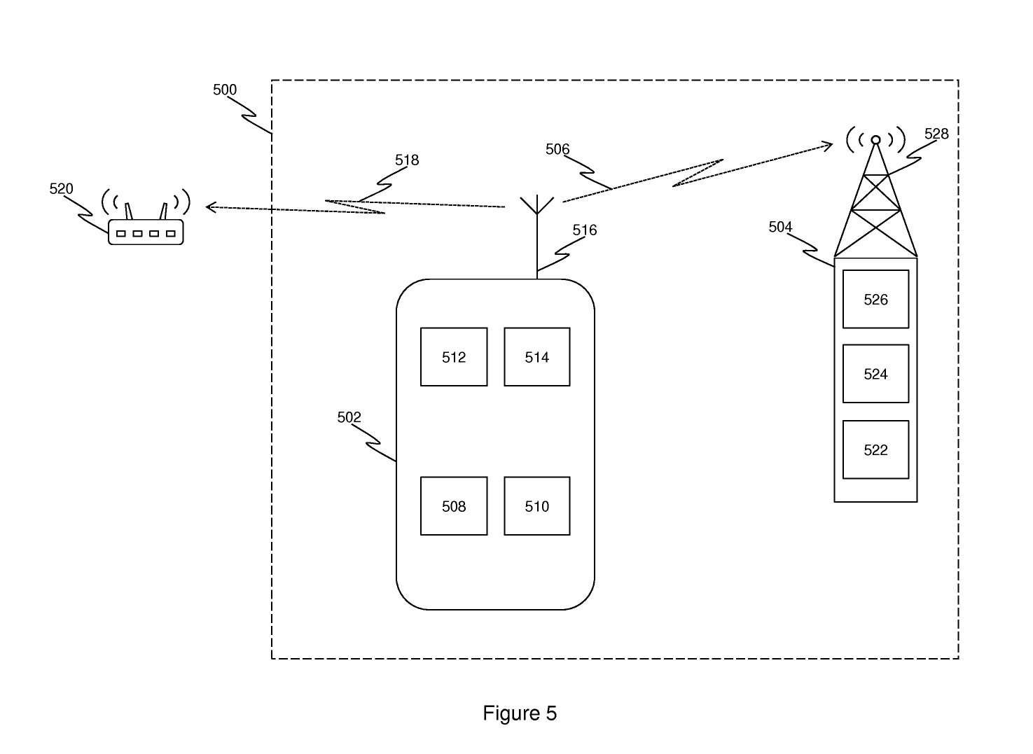

FIG. 5 shows a schematic diagram of a wireless communications network 500 in which embodiments may be practised. The wireless communications network 500 comprises a user equipment (UE), in this case in the form of mobile telephone 502 and a network entity 504. UE 502 and network entity 504 are connected via wireless communication link 506. According to embodiments, wireless communications network 500 comprises a cellular wireless network, such as a UMTS (Universal Mobile Telecommunications System) or an LTE (Long Term Evolution) network. In practice, there will typically be many UEs serviced by the wireless communications network 500 and perhaps by network entity 504 in particular.

UE 502 has a memory 508, a processor 510, a number of radio modules and at least one antenna 516 for enabling wireless communication with one or more wireless networks. In this case, UE 502 comprises radio module 512 for conducting communications with network entity 504 in wireless communications network 500 via wireless communications link 506, and radio module 514 for conducting wireless communications in another network via wireless communications link 518. Wireless communication link 518 is established in a non-cellular wireless network (for example Wi-Fi, Bluetooth, Satellite etc.) in this case with Wi-Fi access point 520 in a Wi-Fi network. Alternatively, wireless link 506 and wireless link 518 may both be cellular communications links used for communications with entities in one or more cellular networks. Alternatively still, wireless link 506 and wireless link 518 may both be non-cellular communications links used for communications with entities in one or more non-cellular networks.

As is known, one or more of radio module 512 and radio module 514 comprise a radio link control entity and a radio resource control entity. The radio link control entity may further comprise a transmitter part and a receiver part. In the arrangement shown in FIG. 5, radio modules 512 and 514 are shown to both communicate via antenna 516. In practice, antenna 516 may comprise a number of antennas which could used for diversity and/or MIMO (multiple in/multiple out) purposes, or allocated between radio modules 512 and 514 such that each radio module is equipped to conduct wireless communications via its own antenna(s).

Network entity 504 has a memory 522, a processor 524, a radio module 526 and an antenna 528 to enable communications with UE 502 via wireless communications link 506. Radio module 526 may comprise a radio link control entity (not shown) and a radio resource control entity (not shown). The radio link control entity may comprise a transmitter part and a receiver part. Network entity 504 may comprise a single entity, or a distributed set of entities. As a particular example in the context of UMTS (Universal Mobile Telecommunications System), network entity 504 may comprise a network control apparatus (e.g. a so-called Radio Network Controller) operating in conjunction with one or more Node Bs. As an example in the context of LTE (Long Term Evolution) network entity 504 may comprise an evolved Node B (eNB) where the RF transceiver and resource management/control functions are combined into a single entity. The term “network entity” is used in this specification to include a “traditional” base station, a Node B or an evolved Node B (eNB), either alone or in combination with one or more further entities such as a radio network controller, or any other access point to a network unless the context requires otherwise.

The network entity 504 and the UE 502 communicate data and control signals to and from each other via the wireless communications network 500. This data is transmitted as frames of information in both an uplink and a downlink direction. An uplink transmission from radio module 512 via wireless communication link 512 may cause in-device interference at a frequency which degrades downlink transmissions received at radio module 514 via wireless communication link 518. Similarly, an uplink transmission from radio module 514 via wireless communication link 518 may cause in-device interference at a frequency which degrades downlink transmissions received at radio module 512 via wireless communication link 506. In order to mitigate the effects of the in-device interference, UE 502 is capable of performing autonomous denials in relation to scheduled uplink transmissions. However, in order to limit the number of autonomous denials that may be made by UE 502, no more than a predetermined number of autonomous denials are permitted to be made within a specific time period.

In order to accurately synchronise this time period between UE 502 and network entity 504, embodiments leverage a system frame number associated with the network entity to form the basis of the synchronisation. The system frame number (SFN) is a value maintained in synchronisation by one or more entities in the wireless communications network, such base stations, Node Bs, evolved Node Bs, radio network controllers etc. The purpose of the SFN is to provide a basis for scheduling the various actions performed by the network entity, such as transmitting a given downlink transmission. The value of the SFN is regularly incremented by a system clock or similar component (also known as the SFN oscillator). By using the SFN as the basis for the synchronisation of the time period between UE 502 and network entity 504, embodiments ensure that the UE and the network entity have the same understanding of the location in the sequence of transmissions that the time period spans. Hence, network entity 504 is effectively enabled to assess whether the number of unsuccessful transmissions during the time period exceeds the predetermined number of autonomous denials that UE 502 was permitted to perform.

For the purpose of a communication session with a given endpoint, such as UE 502, the SFN is used to derive a connection frame number (CFN), which is used to consecutively number each frame in that communication session. According to embodiments, the CFN, derived from the SFN, is used as the basis of the synchronisation between UE 502 and the network entity 504.

Synchronisation of the time period is configured by network entity 504. For example, the network entity may generate an indicator for a start time of the time period, which is derived on the basis of the SFN and transmit the indicator to UE 502 in a time period configuration message. The UE then uses the received indicator to determine the start time of the time period. Conveniently UE 502 is adapted to further respond to receipt of the configuration message by configuring the UE, on the basis of the indicator, to perform no more than a predetermined number of autonomous denials during the time period.

In some embodiments, the indicator comprises the SFN that corresponds to the intended start time of the time period. The indicator may comprise only a part of that SFN, for example the least significant n bits, such that the actual SFN that corresponds to the intended start time of the time period can be inferred by UE 502 based on proximity to a current SFN. The UE 502 may determine the next sequential SFN having the bits comprised in the indicator. In this arrangement the SFN is effectively truncated, and thus has the effect of reducing the size (number of bits) of the indicator required to be sent to the UE, and therefore provides corresponding efficiency savings. The least significant n bits of the SFN may also be used to generate a sequence of start and/or times of time periods by identifying a plurality of sequential SFNs having the those bits comprised in the indicator.

For the purpose of a communication session between network entity 504 and a given endpoint, such as UE 502, the SFN is used to derive a connection frame number (CFN), which is used to consecutively number each frame in that communication session. According to embodiments, the CFN, derived from the SFN is used as the basis of the synchronisation between UE 502 and network entity 504. The indicator may comprise either the whole or a part of the CFN, as described analogously above in relation to the SFN.

In some arrangements, the configuration message further comprises an end time for the time period, derived on the basis of the SFN or the CFN. The end of the time period may also comprise the start time of a subsequent time period. Alternatively, an end time for the time period may be communicated to the UE 502 in a subsequent configuration message sent from network entity 504.

The configuration message may comprise a duration, which can be determined by network entity 504 or may be predetermined and stored in memory at network entity 504. In alternative arrangements, the duration may be predetermined and stored in memory on UE 502. According to embodiments, UE 502 identifies the end time of the time period by adding the duration to a determined start time for the time period. The duration may comprise a number of frames, or alternatively a number of seconds. The start and/or end times of time periods subsequent to the time period can be calculated through repeated addition in the same manner.

In alternative arrangements, the start time of the time period may be determined on the basis of the duration, without requiring the indicator to comprise a part of the SFN and/or CFN. In some embodiments, the indicator comprises the duration. Where the duration comprises a number of frames, performing a modulo operation on either the SFN or the CFN using the duration results in the generation of a repeating sequence of start and/or end times of time periods, each separated by the duration associated with the time period. UE 502 may then infer the intended start time of the time period based on proximity to a current SFN or CFN, for example by selecting the next SFN that occurs in the generated sequence.

In order for the time period to be configured to start at any given time, an offset value can be utilised to adjust the start time and/or end time of the time period. The offset value may be determined by network entity 504 in order to schedule the time period to start at a given time or alternatively the offset value may be predetermined and stored in memory at network entity 504. In some arrangements the configuration message comprises the offset value, while in others the offset value is predetermined and stored in memory at UE 502. In some arrangements, indicator comprises the offset value.

Alternatively still, the offset value may be calculated by UE 502 on the basis of the point in time at which the configuration message is received at the UE. For example, this may comprise comparing the time at which the configuration message is received with a determined start time of the time period (determined for example by performing a modulo operation), wherein the difference between these times comprises the offset value. The offset value may comprise a number of frames, or alternatively a number of seconds. In addition, or as an alternative, to being used to adjust the start time and/or end of the time period, the offset value can be used to adjust the start time and/or end time of each subsequent time period.

The configuration message may comprise the predetermined number of autonomous denials, or alternatively the predetermined number of autonomous denials can be stored in memory on UE 502. The predetermined number of autonomous denials could also be stored in memory at network entity 504.

In embodiments, UE 502 may comprise an autonomous denial counter which is utilised to ensure that no more than the predetermined number of autonomous denials are performed during the time period. The autonomous denial counter is incremented by the UE each time an autonomous denial is performed, for example in response to performing the autonomous denial. UE 502 is configured to compare the value of the autonomous denial counter to the predetermined number of autonomous denials prior to performing a given autonomous denial, so that the given autonomous denial may be selectively performed by UE 502 on the basis of the comparison. For example, if the result of the comparison shows that the predetermined number of autonomous denials have already been performed, or that performing the given autonomous denial would increase the autonomous denial counter past the predetermined value, then autonomous denial is not performed.

In the embodiments described above, autonomous denials have been described in relation to uplink transmissions that are optionally not performed by UE 502 in order to enable effective receipt of downlink transmissions via another radio module that would otherwise be subjected to in-device interference. However, according to further embodiments, autonomous denials may also, or alternatively, be performed in relation to downlink transmissions. Autonomous denial of a downlink transmission may comprise foregoing effective receipt of the downlink transmission in order to transmit an uplink transmission via another radio module which results in the autonomously denied downlink transmission being subject to in-device interference. In some cases, when a downlink transmission is autonomously denied this also results in the loss of an uplink grant and therefore also denies a subsequent uplink transmission. Hence, in some arrangements, the autonomous denial counter is incremented twice when an autonomous denial is performed in relation to a downlink transmission. The UE 502 may be further configured to first determine whether the autonomous denial of the downlink transmission will result in the denial of a subsequent uplink transmission. If so, the autonomous denial counter is incremented twice; otherwise the autonomous denial counter is incremented only once.

As described above, the configuration message may be used to determine the start and/or end times of one or more time periods subsequent to the time period. Accordingly, in some arrangements, UE 502 may be adapted to respond to receipt of the configuration message by configuring the UE, on the basis of the indicator, to perform no more than the predetermined number of autonomous denials during each subsequent time period. By resetting the autonomous denial counter at the start or end of each time period, UE 502 is enabled to perform further autonomous denials in each subsequent time period.

In embodiments, network entity 504 may comprise an unsuccessful transmission counter for monitoring the number of unsuccessful transmissions that occur in the given time period. The unsuccessful transmission counter may be incremented each time the monitoring detects an unsuccessful transmission. By comparing the value of the unsuccessful transmission counter to the predetermined number of autonomous denials, network entity 504 can determine whether a given unsuccessful transmission is attributable to an autonomous denial performed by UE 502. For example, if the number of unsuccessful transmissions detected (i.e. the value in the unsuccessful transmission counter) is less than or equal to the number of autonomous denials that UE 502 is permitted to perform, then it is possible that the unsuccessful transmissions are a result of autonomous denials performed by the UE. However, if the number of unsuccessful transmissions detected exceeds the number of autonomous denials that UE 502 is permitted to perform in the time period, then network entity 504 can determine that at least one of the unsuccessful transmissions is a result of poor link quality. This therefore enables the network entity 504 to more precisely pinpoint the cause of unsuccessful transmissions. In some arrangements, the unsuccessful transmission counter is incremented twice if the unsuccessful transmission is a downlink transmission, and the comparison may be usefully performed in response to the monitoring detecting an unsuccessful transmission.

Upon determining that at least one of the unsuccessful transmissions is a result of poor link quality between UE 502 and network entity 504, the network entity may take action to improve the quality of the link, for example by modifying resource usage within wireless communications network 500. In this way, embodiments provide a means of selectively adapting resource usage within the wireless communications network 500 on the basis of the result of the comparison. Suitable modifications to resource usage include one or more of performing a link adaption operation, changing the centre frequency of the one or more of the uplink and or downlink transmissions, increasing transmitted signal power etc.

Network entity 504 may be further configured to monitor the number of unsuccessful transmissions in one or more time periods subsequent to the time period. In such arrangements, the unsuccessful transmission counter is reset at the start or end of each time period, which has the effect of enabling the network entity 504 to more precisely pinpoint the cause of unsuccessful transmissions in each subsequent time period.

In the embodiments described above, the SFN has been utilised as the basis for synchronisation between UE 502 and network entity 504. However, according to further envisaged embodiments, other equivalent transmission/frame/packet numbering metrics may be used to provide suitable synchronisation. Indeed, while the embodiments described above have been described in relation to a cellular wireless network such as UMTS or LTE, further embodiments are envisaged to operate in other wireless networks wherein an analogous alternative to the SFN parameter is utilised.

While the embodiments described above describe a UE in relation to a mobile telephony device, a UE may comprises any device capable of conducting wireless communications, and includes in particular mobile devices such as mobile or cell phones, personal digital assistants, pagers, tablet and laptop computers, content-consumption or generation devices (for music and/or video data for example), as well as fixed or relatively static devices, such as personal computers, game consoles and other generally static entertainment devices. A user equipment may also comprise a separate module such as a data card, modem device, USB dongle, chip, chipset, system in package (SIP) etc. which can be attached to various devices, including consumer electronics, cars, measuring devices, sensors, public safety devices, security or supervision systems or other public authority electronics, billboards, positioning systems etc. to facilitate wireless communications.

It will be understood that the processor or processing system or circuitry of the UE and/or network entity referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

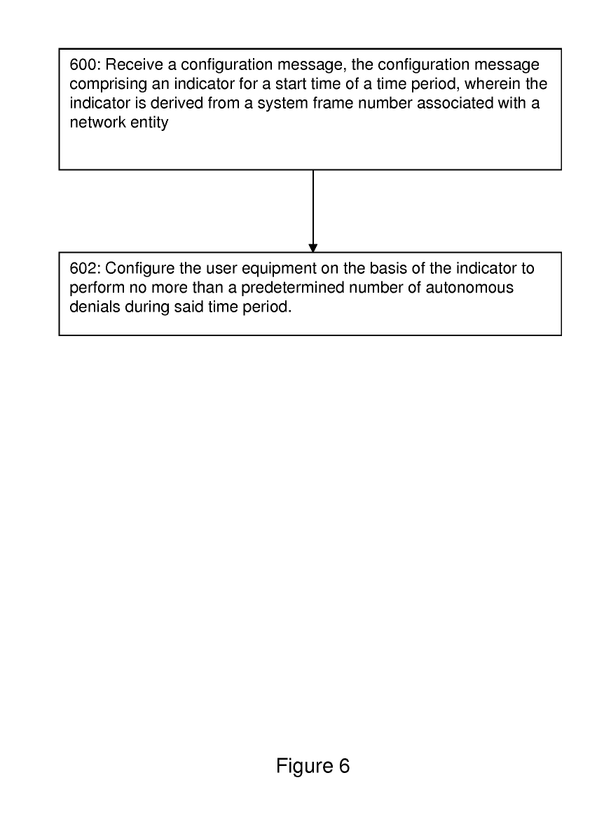

FIG. 6 is a flow diagram that describes embodiments from the perspective of UE 502, and in this regard, FIG. 6 represents steps performed by one or a combination of the aforementioned control circuitry, digital signal processor, processing system or processors, baseband circuitry and radio frequency circuitry.

At step 600, a configuration message is received at the user equipment, the configuration message comprising an indicator for a start time of a time period, wherein the indicator is derived from a system frame number associated with a network entity. At step 602 the user equipment is configured on the basis of the indicator to perform no more than a predetermined number of autonomous denials during the time period.

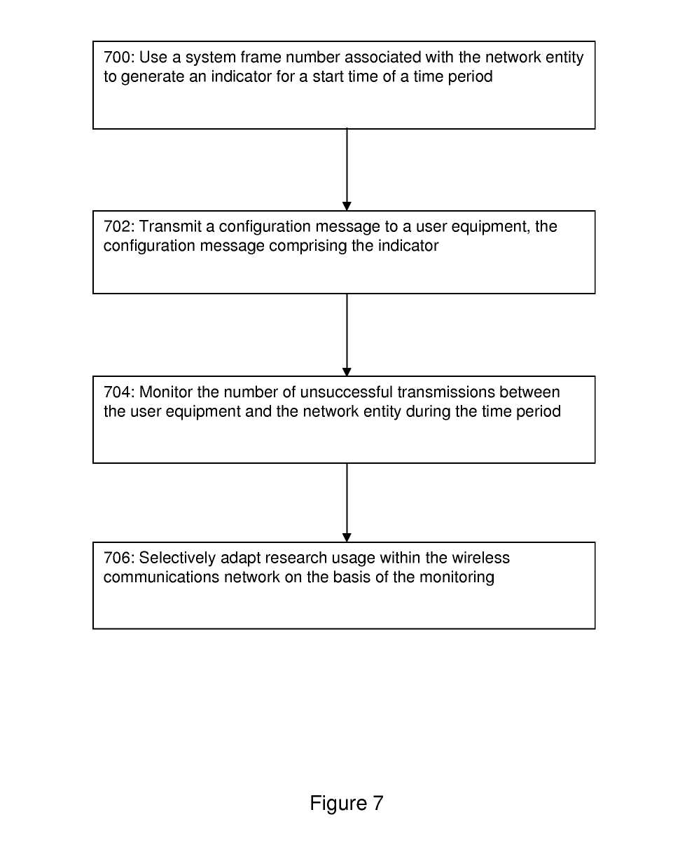

FIG. 7 is a flow diagram that describes embodiments from the perspective of network entity 504, and in this regard, FIG. 7 represents steps performed by one or a combination of the aforementioned control circuitry, digital signal processor, processing system or processors, baseband circuitry and radio frequency circuitry.

At step 700, a system frame number associated with the network entity is used to generate an indicator for a start time of a time period. At step 702, a configuration message is transmitted to a user equipment, the configuration message comprising the indicator. At step 704, the number of unsuccessful transmissions between the user equipment and the network entity during the time period is monitored. At step 706, resource usage within the wireless communications network is selectively adapted on the basis of the monitoring

The above embodiments are to be understood as illustrative examples of the invention. Further embodiments of the invention are envisaged. For example, the time period and/or predetermined number of autonomous denials could be configured by the UE rather than the network entity, and in such embodiments the configuration message may be sent from the UE to the network entity. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of controlling autonomous denials in relation to transmissions between a user equipment and a network entity in a wireless communications network, wherein the network entity has a system frame number associated therewith, the method comprising:
receiving, at the user equipment, a configuration message, the configuration message comprising an indicator for a start time of a time period, wherein the indicator is derived from the system frame number; and
configuring the user equipment on the basis of the indicator to perform no more than a predetermined number of autonomous denials during said time period.

2. A method according to claim 1, wherein the indicator comprises at least a part of the system frame number.

3. A method according to claim 1, wherein the indicator comprises at least a part of a connection frame number, the connection frame number having been derived from the system frame number.

4. A method according to claim 1 wherein the configuring is further performed on the basis of a duration associated with the time period, wherein the configuration comprises determining, at least on the basis of the duration, one or more of an end time of the time period and a start time of a subsequent time period.

5. A method according to claim 4 wherein the determining comprises adding the duration to the start time of the time period.

6. A method according to claim 4 wherein the determining comprises performing a modulo operation using the duration.

7. A method according to claim 4, wherein the configuration message comprises the duration.

8. A method according to claim 7, wherein the indicator comprises the duration.

9. A method according to claim 4, wherein the duration is predetermined and stored at the user equipment.

10. A method according to claim 4, wherein the duration comprises a number of seconds.

11. A method according to claim 4, wherein the duration comprises a number of frames.

12.-24. (canceled)

25. A method of controlling resource usage within a wireless communications network, the wireless network comprising a user equipment and a network entity, wherein the network entity has a system frame number associated therewith, the method comprising:
using the system frame number to generate an indicator for a start time of a time period;
transmitting a configuration message to the user equipment, the configuration message comprising the indicator;
monitoring the number of unsuccessful transmissions between the user equipment and the network entity during said time period; and
selectively adapting resource usage within the wireless communications network on the basis of the monitoring.

26. A method according to claim 25, wherein the indicator comprises at least a part of the system frame number.

27.-42. (canceled)

43. Apparatus for controlling autonomous denials in relation to transmissions between a user equipment and a network entity in a wireless communications network, the apparatus comprising
a processing system arranged, responsive to receipt of a configuration message comprising an indicator for a start time of a time period, to configure the user equipment on the basis of the indicator to perform no more than a predetermined number of autonomous denials during said time period, wherein the indicator is derived from a system frame number associated with the network entity.

44. Apparatus according to claim 43, comprising a memory adapted to store one or more of:
a duration associated with the time period,
an offset value used to adjust one or more of a start time and an end time of the time period, and
the predetermined number of autonomous denials.

45. Apparatus according to claim 43, wherein the processing system is arranged to increment a counter each time an autonomous denial is performed.

46. Apparatus according to claim 45, wherein the processing system is arranged to:
compare a value of the counter to the predetermined number of autonomous denials prior to performing an autonomous denial; and
cause the apparatus to perform autonomous denial on the basis of the comparison.

47. Apparatus according to claim 45, wherein the processing system is arranged to reset the counter at the start of each said time period.

48. Apparatus according to claim 43, wherein the apparatus comprises a first radio module and a second, different, radio module, wherein at least one of said first radio module and said second radio module are adapted to communicate with the network entity, and wherein the first and second radio modules give rise to in-device interference during certain transmissions between the user equipment and the network.

49. Apparatus according to claim 43, wherein the apparatus comprises one or more or of:
a chipset,
a front end module,
a transceiver, and
the user equipment.

50.-57. (canceled)
